(19) United States
(12) Patent Application Publication
(10) Pub. No.: US 2016/0338813 A1
(43) Pub. Date: Nov. 24, 2016

(54) TOOL FOR OBTAINING DENTAL OCCLUSION IN EDENTULOUS PATIENT

(71) Applicant: GC Corporation, Tokyo (JP)

(72) Inventor: Hiroshi KAMOHARA, Tokyo (JP)

(21) Appl. No.: 15/229,395

(22) Filed: Aug. 5, 2016

Related U.S. Application Data
(63) Continuation of application No. PCT/JP2015/054088, filed on Feb. 16, 2015.

(30) Foreign Application Priority Data
Feb. 25, 2014 (JP) 2014-033869

(51) Int. Cl. A61C 19/05; A61C 13/00

(52) U.S. Cl. CPC A61C 19/05; A61C 13/0003

(57) ABSTRACT

A tool for obtaining a dental occlusion in an edentulous patient has a main body including a rear curved plate to be positioned at an intraoral buccal of maxillary and mandibular ridges, a front curved plate to be positioned at extraoral upper and lower lips, a connecting part that connects respective intermediate parts of the rear and front curved plates along a vertical direction, and a through-hole that penetrates the rear and front curved plates and the connecting part, fixed in a state in which the connecting part is held between the upper and lower lips. The tool further includes an adjusting shaft inserted into the through-hole, and having one end projecting extraorally from a center between the upper and lower lips, and another end having a tongue support and intraorally holding a tip end of a tongue, to adjust the tongue support position and suppress tongue movement.

### CROSS-REFERENCE TO RELATED APPLICATIONS

This application is a continuation application of International Application No. PCT/JP2015/054088 filed on Feb. 16, 2015 and designating the U.S., which is based on and claims the benefit of priority of Japanese Patent Application No. 2014-033869 filed in the Japan Patent Office on Feb. 25, 2014, the entire contents of which are incorporated herein by reference.

### BACKGROUND OF THE INVENTION

1. Field of the Invention

The present invention relates to a tool for obtaining a dental occlusion in an edentulous patient.

2. Description of the Related Art

When making a complete denture for the edentulous patient, generally, impressions of maxillary and mandibular ridges are respectively taken first, and an intraoral plaster model is then made from the impressions.

In addition, a wax rim formed on the intraoral plaster model is used to obtain the dental occlusion in order to determine a occlusal position. Next, a dental technician or the like mounts the intraoral plaster model on an articulator, and the complete denture or the like for the edentulous patient is made according to an ordinary method.

Obtaining the dental occlusion in this manner requires skill and experience, and a large difference may occur amongst practitioners. When an accurate dental occlusion cannot be obtained, the complete denture that is provided may not suit the patient. In some cases, the dental occlusion may need to be obtained again, and a new complete denture or the like may need to be made.

When making the complete denture or the like for the edentulous patient in the above described manner, a denture making method has been proposed to be able to determine a median, an occlusal plane, or the like (for example, refer to Japanese Laid-Open Patent Publication No. 2004-8487). According to this proposed method, when obtaining the dental occlusion, a fitting tool for making the denture is fixed to a suitable position on the maxillary wax rim to embed artificial teeth in it, and that fitting tool has six thin dummy teeth in total, which are integrated into one piece, have a standard front shape of anterior teeth of maxilla.

The proposed method described above mounts the dummy teeth (which is the fitting tool for making the denture) on the wax rim recorded the dental occlusion on it to provide a mark of the median or the like, in order to accurately notify the median or the like from a dentist to the dental technician (for example, refer to FIG. 2 of Japanese Laid-Open Patent Publication No. 2004-8487). The obtaining of the dental occlusion itself is in accordance with the conventional method (for example, refer to paragraph numbers 0016 and 0017 of Japanese Laid-Open Patent Publication No. 2004-8487), and the proposed method does not provide a solution to the problem in that it is difficult to accurately determine the occlusal position.

### SUMMARY OF THE INVENTION

Accordingly, one object of the present invention is to provide a tool for obtaining a dental occlusion in an edentulous patient, which can accurately record a occlusal position of the edentulous patient by a simple method.

According to one aspect of the present invention, a tool for obtaining a dental occlusion in an edentulous patient, includes a main body including a rear curved plate, a front curved plate, a connecting part that connects respective intermediate parts of the rear curved plate and the front curved plate along a vertical direction, and a through-hole that penetrates the rear curved plate, the front curved plate, and the connecting part; and an adjusting shaft, inserted into the through-hole of the main body, and having a first end and a second end including a tongue support, wherein, in a state in which the rear curved plate is positioned at an intraoral buccal of maxillary and mandibular ridges of the edentulous patient, the front curved plate is positioned at extraoral upper and lower lips of the edentulous patient, a position of the main body is fixed in a state in which the connecting part is held between the upper and lower lips, the first end of the adjusting shaft projects extraorally from a center between the upper and lower lips, and the second end of the adjusting shaft which has the tongue support, intraorally holds a tip end of a tongue, and wherein the adjusting shaft adjusts a position of the tongue support to suppress movement of the tongue when obtaining the dental occlusion.

Other objects and further features of the present invention will be apparent from the following detailed description when read in conjunction with the accompanying drawings.

### BRIEF DESCRIPTION OF THE DRAWINGS

FIG. 1 is a perspective view illustrating one embodiment of a tool for obtaining a dental occlusion in an edentulous patient according to the present invention;

FIG. 2 is a plan view of the tool for obtaining the dental occlusion in the edentulous patient illustrated in FIG. 1;

FIG. 3 is a plan view illustrating a state in which an adjusting shaft is removed from a main body of the tool for obtaining the dental occlusion in the edentulous patient illustrated in FIG. 1;

FIG. 4 is a plan view illustrating a state in which an impression material is applied on the tool for obtaining the dental occlusion in the edentulous patient illustrated in FIG. 1; and

FIG. 5 is a perspective illustrating another embodiment of the tool for obtaining the dental occlusion in the edentulous patient according to the present invention.

### DESCRIPTION OF THE PREFERRED EMBODIMENTS

A detailed description will hereinafter be given of illustrative embodiments of the tool for obtaining the dental occlusion in the edentulous patient according to the present invention, by referring to the drawings.

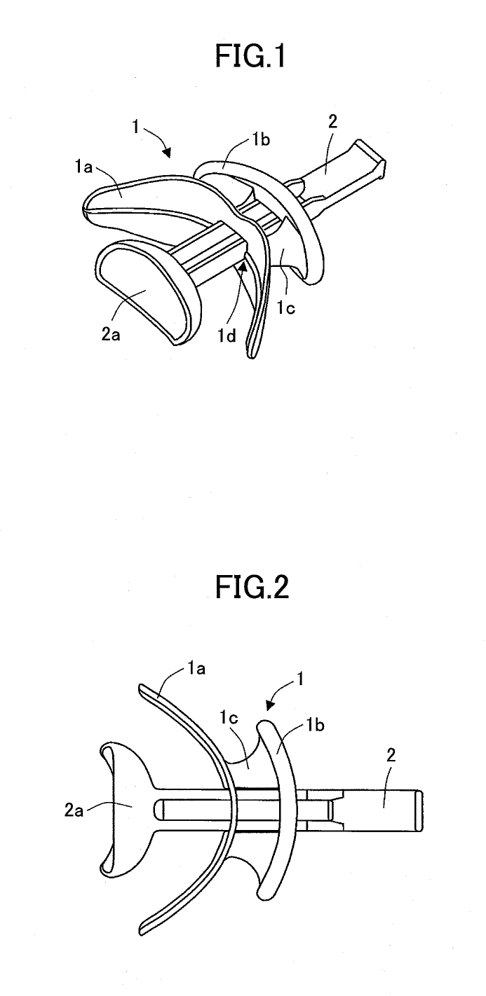

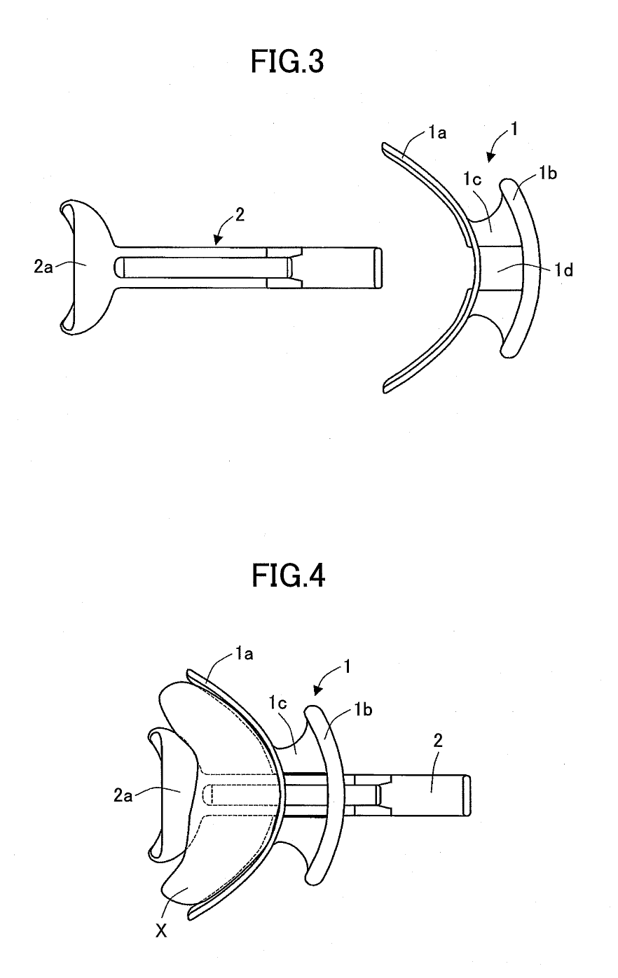

FIG. 1 is a perspective view illustrating one embodiment of the tool for obtaining the dental occlusion in the edentulous patient according to the present invention. FIG. 2 is a plan view of the tool for obtaining the dental occlusion in the edentulous patient illustrated in FIG. 1, and FIG. 3 is a plan view illustrating a state in which an adjusting shaft is removed from a main body of the tool for obtaining the dental occlusion in the edentulous patient illustrated in FIG. 1. In addition, FIG. 4 is a plan view illustrating a state in which an impression material is applied on the tool for obtaining the dental occlusion in the edentulous patient illustrated in FIG. 1.

The tool for obtaining the dental occlusion in the edentulous patient includes a main body 1, and an adjusting shaft 2 illustrated in FIGS. 1 through 4. In FIG. 4, an impression material X that is used when obtaining the dental occlusion is applied to an intraoral side of a rear curved plate 1a of the main body 1 which will be described later. The impression material X is used not only for maxillary and mandibular ridges in their entirety, but also for obtaining the dental occlusion at least between the maxillary and mandibular ridges at the anterior teeth.

In FIGS. 1 through 4, the main body 1 includes the rear curved plate 1a to be positioned at an intraoral buccal of the maxillary and mandibular ridges of the edentulous patient, a front curved plate 1b to be positioned at extraoral upper and lower lips of the edentulous patient, a connecting part 1c that connects respective intermediate parts of the rear curved plate 1a and the front curved plate 1b along a vertical direction, and a through-hole 1d that penetrates the rear curved plate 1a, the front curved plate 1b, and the connecting part 1c. The position of the main body 1 is fixed in a state in which the connecting part 1c is held between the upper and lower lips.

The main body 1 is preferably formed by a material, such as a resin or the like, that is both soft and strong, because the main body 1 is held between the soft upper and lower lips.

Further, the main body 1 needs to do no harm to the human body, because the main body 1 is intraorally inserted into together with the adjusting shaft 2 which will be described later. In addition, the main body 1 is preferably not damaged nor deformed even when an autoclave process is performed, for example, so that the main body 1 can be reused.

The adjusting shaft 2 is inserted into the through-hole 1d of the main body 1, and includes a tongue support 2a. The adjusting shaft 2 has one end thereof projecting extraorally from a center between the upper and lower lips, and another end which has a tongue support 2a, thereof intraorally holding a tip end of a tongue. The adjusting shaft 2 adjusts the position of the tongue support 2a to suppress movement of the tongue when obtaining the dental occlusion.

The dental occlusion in a state in which the tongue is held in a natural state can be obtained by the tongue support 2a of the adjusting shaft 2.

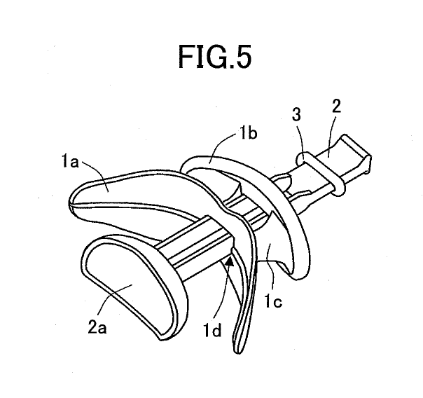

The stopper 3 is formed at a part of the adjusting shaft 2 projecting further from the front curved plate 1b. It is preferable to provide the stopper 3, because the stopper 3 can prevent the adjusting shaft 2 from intraorally falling from the main body 1, which may otherwise cause accidental swallowing, choking, or the like. The stopper 3 may be integrally formed on the adjusting shaft 2, or may be made of a ring-shaped rubber member or the like as illustrated in FIG. 5, for example. FIG. 5 is a perspective illustrating another embodiment of the tool for obtaining the dental occlusion in the edentulous patient according to the present invention.

First, when actually using the tool for obtaining the dental occlusion in the edentulous patient according to the present invention to make the complete denture or the like for the edentulous patient, the impression material X is applied intraorally on the rear curved plate 1a of the main body 1, together with the adjusting shaft 2, and the main body 1 is intraorally inserted into the edentulous patient as illustrated in FIG. 4. Preferably, a groove or the like is formed at the rear curved plate 1a of the main body 1 or the adjusting shaft 2 that is intraorally inserted, to improve the effect of holding the impression material X applied thereon.

Next, the edentulous patient is urged to slowly close his or her mouth so that the upper and lower lips make contact, in order to hold the connecting part 1c between the rear curved plate 1a and the front curved plate 1b of the main body 1, and to slowly spread the impression material X between the maxillary and mandibular ridges. By obtaining the dental occlusion in a state in which the upper and lower lip positions are fixed, maxillary and mandibular positions do not become unnatural, and it is possible to obtain the dental occlusion in a simple manner urging the edentulous patient to slowly close his or her mouth. In addition, an accurate dental occlusion can be obtained in a state in which the tongue is held in a natural state by the tongue support 2a of the adjusting shaft 2.

Furthermore, impressions of the maxillary and mandibular ridges, that become a base for the intraoral shape of the edentulous patient, are obtained. Intraoral impression models are made from these impressions.

These intraoral impression models of the maxillary and mandibular ridges that are made as described above are set on an articulator, and based on the impressions obtained by the dental occlusion that is obtained beforehand, the size and position of the denture are determined to make the complete denture or the like.

A method that does not use the impression models or the articulator may obtain electronic data by performing a 3-dimensional scan on the intraoral impressions of the maxillary and mandibular ridges obtained beforehand, or the impressions obtained by the dental occlusion that is obtained beforehand. In this case, a computer may determine the size and position of the denture according to the electronic data, and make the complete denture or the like using an automatic cutting machine or the like.

By using the above described tool for obtaining the dental occlusion in the edentulous patient, the occlusal position of the edentulous patient can be accurately recorded in a simple manner.

The present inventor confirmed that, when obtaining the dental occlusion in the edentulous patient, the positions of the lips and the position of the tongue can be maintained in natural states by using the tool for obtaining the dental occlusion in the edentulous patient according to each embodiment described above, and thus, it is possible to obtain an accurate dental occlusion. More particularly, a main body of the tool includes a rear curved plate to be positioned at the intraoral buccal of the maxillary and mandibular ridges of the edentulous patient, a front curved plate to be positioned at extraoral upper and lower lips of the edentulous patient, a connecting part that connects respective intermediate parts of the rear curved plate and the front curved plate along a vertical direction, and a through-hole that penetrates the rear curved plate, the front curved plate, and the connecting part. The position of the main body is fixed in a state in which the connecting part is held between the upper and lower lips. An adjusting shaft of the tool is inserted into the through-hole of the main body, and includes a tongue support. The adjusting shaft has one end thereof projecting extraorally from a center between the upper and lower lips, and another end which has a tongue support, thereof intraorally holding a tip end of a tongue. The adjusting shaft adjusts the position of the tongue support to suppress movement of the tongue when obtaining the dental occlusion. Hence, it was confirmed that the dental occlusion can be obtained in a state in which the tongue is held in a natural state by the tongue support of the adjusting shaft, and maxillary and mandibular positions do not become fixed to unnatural positions. In addition, it was confirmed that the dental occlusion can be obtained in a relaxed state in which the edentulous patient holds the connecting part of the main body by contacting his or her upper and lower lips. Furthermore, it was confirmed that the dental occlusion can be obtained in a state in which the tongue is held in the natural state by the tongue support of the adjusting shaft that is inserted into the through-hole of the main body.

In other words, in one embodiment of the present invention, the tool for obtaining the dental occlusion in the edentulous patient includes the main body and the adjusting shaft. The main body of the tool includes the rear curved plate to be positioned at the intraoral buccal of the maxillary and mandibular ridges of the edentulous patient, the front curved plate to be positioned at the extraoral upper and lower lips of the edentulous patient, the connecting part that connects the respective intermediate parts of the rear curved plate and the front curved plate along the vertical direction, and the through-hole that penetrates the rear curved plate, the front curved plate, and the connecting part. The position of the main body is fixed in the state in which the connecting part is held between the upper and lower lips. The adjusting shaft of the tool is inserted into the through-hole of the main body, and includes the tongue support. The adjusting shaft has one end thereof projecting extraorally from the center between the upper and lower lips, and another end which has a tongue support, thereof intraorally holding the tip end of the tongue. The adjusting shaft adjusts the position of the tongue support to suppress the movement of the tongue when obtaining the dental occlusion.

The tool for obtaining the dental occlusion in the edentulous patient includes the main body and the adjusting shaft. The main body of the tool includes the rear curved plate to be positioned at the intraoral buccal of the maxillary and mandibular ridges of the edentulous patient, the front curved plate to be positioned at the extraoral upper and lower lips of the edentulous patient, the connecting part that connects the respective intermediate parts of the rear curved plate and the front curved plate along the vertical direction, and the through-hole that penetrates the rear curved plate, the front curved plate, and the connecting part. The position of the main body is fixed in the state in which the connecting part is held between the upper and lower lips. The adjusting shaft of the tool is inserted into the through-hole of the main body, and includes the tongue support. The adjusting shaft has one end thereof projecting extraorally from the center between the upper and lower lips, and another end which has a tongue support, thereof intraorally holding the tip end of the tongue. The adjusting shaft adjusts the position of the tongue support to suppress the movement of the tongue when obtaining the dental occlusion. For this reason, the dental occlusion can be obtained in the state in which the tongue is held in the natural state by the tongue support of the adjusting shaft, and the maxillary and mandibular positions do not become fixed to unnatural positions. In addition, the dental occlusion can be obtained in the relaxed state in which the edentulous patient holds the connecting part of the main body by placing his or her upper and lower lips on the connecting part. Furthermore, the dental occlusion can be obtained in the state in which the tongue is held in the natural state by the tongue support of the adjusting shaft that is inserted into the through-hole of the main body.

In addition, a stopper may be formed at a part of the adjusting shaft projecting further from the front curved plate. It was confirmed that this stopper can prevent the adjusting shaft from intraorally falling from the main body, which may otherwise cause accidental swallowing, choking, or the like.

By forming the stopper at the part of the adjusting shaft projecting further from the front curved plate, it is preferable in that this stopper can prevent the adjusting shaft from intraorally falling from the main body, which may otherwise cause accidental swallowing, choking, or the like.

According to illustrative embodiments of the present invention, it is possible to provide a tool for obtaining a dental occlusion in an edentulous patient, which can accurately record a occlusal position of the edentulous patient by a simple method.

Although the disclosed tools for obtaining the dental occlusion in the edentulous patient are described by way of embodiments, the present invention is not limited to the above described embodiments, and various variations and modifications may be made within the scope of the present invention.

What is claimed is:

1. A tool for obtaining a dental occlusion in an edentulous patient, comprising:
a main body including a rear curved plate, a front curved plate, a connecting part that connects respective intermediate parts of the rear curved plate and the front curved plate along a vertical direction, and a through-hole that penetrates the rear curved plate, the front curved plate, and the connecting part; and
an adjusting shaft, inserted into the through-hole of the main body, and having a first end and a second end including a tongue support,
wherein, in a state in which the rear curved plate is positioned at an intraoral buccal of maxillary and mandibular ridges of the edentulous patient, the front curved plate is positioned at extraoral upper and lower lips of the edentulous patient, a position of the main body is fixed in a state in which the connecting part is held between the upper and lower lips, the first end of the adjusting shaft projects extraorally from a center between the upper and lower lips, and the second end of the adjusting shaft which has the tongue support, intraorally holds a tip end of a tongue, and
wherein the adjusting shaft adjusts a position of the tongue support to suppress movement of the tongue when obtaining the dental occlusion.

2. The tool for obtaining the dental occlusion in the edentulous patient as claimed in claim 1, wherein the adjusting shaft includes a stopper that is formed at a part projecting from the front curved plate.
